(19) United States
(12) Patent Application Publication
(10) Pub. No.: US 2021/0008842 A1
(43) Pub. Date: Jan. 14, 2021

(54) COMPOSITE PANE WITH A FUNCTIONAL ELEMENT HAVING ELECTRICALLY CONTROLLABLE OPTICAL PROPERTIES WITH IMPROVED EDGE SEALING

(71) Applicant: SAINT-GOBAIN GLASS FRANCE, COURBEVOIE (FR)

(72) Inventors: Marcel KLEIN, BAESWEILER (DE); Sebastian SCHURSE, ÜBACH-PALENBERG (DE)

(21) Appl. No.: 16/979,736

(22) PCT Filed: Jul. 8, 2019
(86) PCT No.: PCT/EP2019/068223

§ 371 Date: Sep. 10, 2020

(30) Foreign Application Priority Data
Jul. 26, 2018 (EP) 18185750.9

(51) Int. Cl. B32B 17/10

(52) U.S. Cl. CPC B32B 17/10036; B32B 17/10293; B32B 17/10174; B32B 17/10504; B32B 2307/202; B32B 2329/06; B32B 17/10119; B32B 2605/006; B32B 2367/00

(57) ABSTRACT

A composite pane containing a functional element having electrically controllable optical properties includes, in this order, a first pane, a first thermoplastic composite film having at least one plasticizer, a functional element having a peripheral edge, a barrier film having a cutout, into which the functional element is inserted, a second thermoplastic composite film having at least one plasticizer, a second pane, wherein the barrier film surrounds the functional element in a frame-like manner and is in direct contact with the peripheral edge of the functional element, and the barrier film contains at most 0.5 wt.-% plasticizer and prevents the diffusion of plasticizer through the barrier film.

The invention relates to a composite pane with a functional element having electrically controllable optical properties with improved edge sealing and in particular a vehicle pane with a functional element.

In the vehicle sector and in the construction sector, composite panes with electrically controllable functional elements are often used as sun screens or as privacy screens.

Thus, for example, windshields are known in which a sun visor is integrated in the form of a functional element having electrically controllable optical properties. In particular, the transmittance or the scattering behavior of electromagnetic radiation in the visible range is electrically controllable. The functional elements are usually film-like and are laminated into or glued onto a composite pane. In the case of windshields, the driver can control the transmittance behavior of the pane itself relative to sunlight. Thus, a conventional mechanical sun visor can be dispensed with. As a result, the weight of the vehicle can be reduced and space gained in the roof region. In addition, the electrical control of the sun visor is more convenient than the manual folding down of the mechanical sun visor.

Windshields with such electrically controllable sun visors are, for example, known from WO 2014/086555 A1, DE 102013001334 A1, DE 102005049081 B3, DE 102005007427 A1, and DE 102007027296 A1. Functional elements are, moreover, also used as roof panels for shading vehicle glazings, as described, for example, in EP 2010385 B1.

As a result of the local introduction of functional elements, such as controllable sun visors, into the intermediate layer of a composite pane, a local increase in thickness occurs in this region, which can cause stresses in the glass of the pane even including glass breakage. Such differences in thickness can be compensated, for example, by the use of a frame film made of polyvinyl butyral, into which the functional element is inserted. Such a structure is described in EP 2010385 B1.

Typical electrically controllable functional elements contain electrochromic layer structures or single particle device (SPD) films. Further possible functional elements for realizing an electrically controllable sun screen are so-called PDLC functional elements (polymer dispersed liquid crystal). Their active layer contains liquid crystals that are embedded in a polymer matrix. When no voltage is applied, the liquid crystals are oriented in a disorderly fashion, resulting in strong scattering of the light passing through the active layer. When a voltage is applied on the surface electrodes, the liquid crystals align themselves in a common direction and the transmittance of light through the active layer is increased. The PDLC functional element acts less by reducing total transmittance, but, instead, by increasing scattering to ensure protection against glare.

DE 20 2018 102 520 U1 describes a composite pane with a functional element having electrically controllable optical properties and strip-shaped busbars for the electrical contacting of the functional element.

Laminated-in functional elements and in particular PDLC functional elements often have, in the edge region, undesirable aging phenomena, such as brightening and changes in the shading. The diffusion of compounds, in particular of plasticizers, out of the thermoplastic composite films of the composite pane into the active layer of the functional element is considered to be the cause. Sealing the edge region of the functional element prevents the diffusion and provides a remedy, for example, according to US 20110171443 A1, by applying an adhesive strip that closes the open edge of the active layer. However, such an adhesive strip must be manually placed around the open film edge, making automation difficult. Moreover, in particular in the case of complex shaping of the functional element, the adhesive strip causes wrinkling, resulting in an insufficient seal.

WO 2017/157626 A1 relates to a windshield with an electrically switchable functional element inserted as a sun visor in the thermoplastic intermediate layer of the windshield, wherein the thermoplastic intermediate layer is at least partially tinted in the region of the functional element. Edge sealing of the functional element is done by means of an adhesive or an adhesive strip.

According to US 2009/0279004 A1, as an alternative to sealing the peripheral edge of the functional element by means of an adhesive strip, components of the thermoplastic intermediate layer in which the functional element is embedded can also be designed plasticizer-poor.

US 2005/0227061 A1 proposes the use of thin strips of a PET film that are applied to an SPD functional element in its edge regions.

The object of the present invention is, consequently, to develop an improved composite pane that includes a functional element with improved edge sealing and higher aging resistance and to provide a method that enables simplified handling and a high degree of automation.

The object of the present invention is accomplished by a composite pane according to the independent claim 1. Preferred embodiments are apparent from the dependent claims.

The invention relates to a composite pane with a functional element having electrically controllable optical properties with improved edge sealing of the functional element. The composite pane contains at least a first pane, a first thermoplastic composite film, a functional element, a barrier film, a second thermoplastic composite film, and a second pane. The thermoplastic composite films contain, in each case, at least one plasticizer. The functional element includes a peripheral edge and is inserted into the layer stack between the first thermoplastic composite film and the second thermoplastic composite film. The peripheral edge of the functional element is surrounded peripherally in a frame-like manner by the barrier film, with the barrier film being in direct contact with the edge of the functional element. For this, the barrier film has a cutout into which the functional element is inserted. The functional element and the barrier film thus lie in the same plane of the layer stack and touch each other along their edges, with their contact surface substantially orthogonal to the pane surfaces of the composite pane. The barrier film includes at most 0.5 percent by weight of a plasticizer and prevents the diffusion of plasticizer through the barrier film.

This is particularly advantageous since, by means of the structure according to the invention, diffusion of plasticizers and other components out of the thermoplastic composite films into the active layer of the functional element is prevented and the aging resistance of the functional element is thus substantially improved. Moreover, in the composite pane according to the invention, a local difference in thickness between the region with the functional element and the surrounding region is at least partially compensated by the barrier film. According to the invention, the barrier film is not applied overlapping the functional element, but rather merely in its immediate vicinity adjacent the peripheral edge of the functional element, enabling this compensation for differences in thickness. The composite pane with a functional element thus has not only improved aging resistance, but also improve durability through minimization of stresses and glass breakage. Furthermore, as a result of the layer structure according to the invention, the production of the composite pane is simplified, since, possibly, no further thermoplastic frame film is necessary to ensure compensation of local differences in thickness.

In a preferred embodiment of the invention, the immediate layer sequence of the composite pane in the region of the functional element and in the vicinity of the functional element consists of, in this order, the first pane, the first thermoplastic composite film having at least one plasticizer, the functional element with a peripheral edge, the barrier film positioned in the plane of the functional element and having a cutout into which the functional element is inserted, a second thermoplastic composite film having at least one plasticizer, and the second pane. In this context, “region of the functional element” is defined as the region which, after projection of the surface of the functional element onto the first pane and the second pane, lies in each case between these two projections. Referred to as “in the vicinity of the functional element” are the regions of the layer stack adjacent the peripheral edge of the functional element. Such an arrangement is advantageous in terms of a layer stack that is as thin as possible and homogeneous with regard to its thickness profile.

Preferably, the barrier film is used as a continuous frame-like film that has no interruptions within the peripheral frame. In this context, “continuous” means that the barrier film in question surrounding the functional element is interruption-free, i.e., has no breaks. The frame results from the cutout in the region of the functional element. Improved sealing can be achieved by a gapless continuous shape. By comparison, with the use of individual sections of a barrier film, placed in each case along the edges of the functional element, quality problems can occur. For example, air inclusions can occur in the overlapping regions of the individual strip-shaped sections of the barrier films or the plasticizer-containing material of the thermoplastic composite films can penetrate into these regions if there is insufficient overlap. A sheet-wise continuous frame-like embodiment of the barrier film along the referral edge of the functional element is thus advantageous in terms of product quality.

Particularly advantageous is a continuous frame-like barrier film in conjunction with the use of pre-composites comprising a barrier film and a thermoplastic composite film. The frame-like shape is advantageous in terms of the dimensional stability of the barrier films in the pre-composite. This simplifies the insertion of the frame-like barrier film and thus prevents the occurrence of insertion errors, increasing product quality.

The enumeration of the elements of the stack sequence reflects the spatial sequence in which the elements are arranged above one another. The elements are substantially flat and consist of thin layers or sheets with a large lateral extent. It goes without saying that the large surfaces of the respective elements are arranged parallel to one another.

The specification of the sequence does not restrict the temporal sequence. In other words, when producing the stack sequence, it is possible to begin, for example, either with the inner pane or the outer pane. Furthermore, subgroups can be created before the overall assembly of the stack sequence.

The controllable functional element typically comprises an active layer between two surface electrodes. The active layer has the controllable optical properties that can be controlled via the voltage applied to the surface electrodes. The surface electrodes and the active layer are typically arranged substantially parallel to the surfaces of the first pane and the second pane.

The surface electrodes are electrically connected to an external voltage source in a manner known per se. The electrical contacting is realized by means of suitable connecting cables, for example, foil conductors that are optionally connected to the surface electrodes via so-called bus bars, for example, strips of an electrically conductive material or electrically conductive imprints.

The surface electrodes are preferably designed as transparent, electrically conductive layers. The surface electrodes preferably contain at least a metal, a metal alloy, or a transparent conducting oxide (TCO). The surface electrodes can contain, for example, silver, gold, copper, nickel, chromium, tungsten, indium tin oxide (ITO), gallium-doped or aluminum-doped zinc oxide, and/or fluorine-doped or antimony-doped tin oxide. The surface electrodes preferably have a thickness of 10 nm to 2 μm, particularly preferably from 20 nm to 1 μm, most particularly preferably from 30 nm to 500 nm.

The functional element can have, besides the active layer and the surface electrodes, other layers known per se, for example, barrier layers, blocking layers, antireflection layers, protective layers, and/or smoothing layers.

The functional element is preferably present as a multilayer film with two outer carrier films. In such a multilayer film, the surface electrodes and the active layer are arranged between the two carrier films. Here, “outer carrier film” means that the carrier films form the two surfaces of the multilayer film. The functional element can thus be provided as a laminated film that can be processed advantageously. The functional element is advantageously protected by the carrier films against damage, in particular corrosion. The multilayer film contains, in the order indicated, at least one carrier film, one surface electrode, one active layer, another surface electrode, and another carrier film. The carrier film carries, in particular, the surface electrodes and gives a liquid or soft active layer the necessary mechanical stability.

The carrier films preferably contain at least one thermoplastic polymer, particularly preferably plasticizer-poor or plasticizer-free polyethylene terephthalate (PET). This is particularly advantageous in terms of the stability of the multilayer film. The carrier films can, however, also contain or be made of other plasticizer-poor or plasticizer-free polymers, for example, ethylene vinyl acetate (EVA), polypropylene, polycarbonate, polymethyl methacrylate, polyacrylate, polyvinyl chloride, polyacetate resin, casting resins, acrylates, fluorinated ethylene propylenes, polyvinyl fluoride, and/or ethylene-tetrafluoroethylene. The thickness of each carrier film is preferably from 0.1 mm to 1 mm, particularly preferably from 0.1 mm to 0.2 mm. In particular, the carrier films contain or are made of plasticizer-free polyethylene terephthalate.

Typically, the carrier films have in each case an electrically conductive coating that faces the active layer and functions as a surface electrode.

In another advantageous embodiment of a composite pane according to the invention, the functional element is a PDLC functional element (polymer dispersed liquid crystal). The active layer of a PDLC functional element contains liquid crystals that are embedded in a polymer matrix. When no voltage is applied on the surface electrodes, the liquid crystals are oriented in a disorderly fashion, resulting in strong scattering of the light passing through the active layer. When a voltage is applied on the surface electrodes, the liquid crystals align themselves in a common direction and the transmittance of light through the active layer is increased.

In principle, however, it is also possible to use other types of controllable functional elements, for example, electrochromic functional elements or SPD functional elements (suspended particle device). The controllable functional elements mentioned and their mode of operation are known per se to the person skilled in the art such that a detailed description can be dispensed with here.

Functional elements as multilayer films are commercially available. The functional element to be integrated is typically cut in the desired shape and size from a multilayer film of relatively large dimensions. This can be done mechanically, for example, with a knife. In an advantageous embodiment, the cutting is done using a laser. It has been demonstrated that, in this case, the side edge is more stable than with mechanical cutting. With mechanically cut side edges, there can be a risk that the material will pull back, which is visually conspicuous and adversely affects the aesthetics of the pane.

The functional element is joined to the first pane via a region of the first thermoplastic composite film and to the second pane via a region of the second thermoplastic composite film. The first and the second thermoplastic composite film are preferably arranged sheet-wise one over another, with the functional element and the barrier film inserted between the two composite films. The regions of the thermoplastic composite films overlapping the functional element then form the regions that bond the functional elements to the panes.

The composite pane can, for example, be the windshield or the roof panel of a vehicle or another vehicle glazing, for example, a glass partition in a vehicle, preferably in a rail vehicle or a bus. Alternatively, the composite pane can be an architectural glazing, for example, in an outer facade of a building or a glass partition in the interior of a building.

The terms “first pane” and “second pane” arbitrarily describe two different panes. In particular, the first pane can be referred to as an “outer pane” and the second pane as an “inner pane”.

In the context of the invention, when the composite pane is intended, in a window opening of a vehicle or of a building, to separate an interior space from the external environment, the pane (second pane) facing the interior (vehicle interior) is referred to as the “inner pane”. The pane (first pane) facing the external environment is referred to as the “outer pane”. However, the invention is not limited to this.

The composite pane according to the invention contains a functional element having electrically controllable optical properties, which is arranged between a first thermoplastic composite film and a second thermoplastic composite film, at least in sections. The first and second thermoplastic composite film usually have the same dimensions as the first and the second pane. The functional element is preferably film-like.

The invention is, in particular, directed at composite panes whose functional element is realized by a polymer dispersed liquid crystal (PDLC) film since, for such functional elements, there is a significant aging effect that must be reduced.

The thickness of the barrier film and the thickness of the functional element preferably deviate from one another by at most 30%, particularly preferably by at most 20%, in particular by at most 15%. This is advantageous in terms of covering the peripheral edge of the functional element to the greatest extent possible along the edge height. With increasing edge coverage of the functional element by the barrier film, its aging resistance is also increased due to the improved edge sealing. However, the inventors have found that a complete match of the thicknesses of the functional element in the barrier film and, consequently, complete edge coverage is unnecessary for a good result. With regard to the use of standardized film thicknesses, which is advantageous in the production process, it is thus possible to consciously dispense with complete coverage of the edge by the barrier film. Thickness deviations of at most 20% between the functional element and the barrier film have yielded good results. Depending on the complexity of the pane geometry and the local bending of the pane at the position of the functional element, an additional frame film can be dispensed with in this case.

Preferably, the thickness of the barrier film is greater than or equal to the thickness of the functional element.

In a possible embodiment, the thickness of the barrier film and the thickness of the functional element are substantially the same. In this way, particularly good aging resistance can be achieved. Moreover, an additional frame film for compensating local height differences can be dispensed with completely since this height compensation can be done completely via the barrier film and no stresses develop due to height differences.

Preferably, the entire peripheral edge of the functional element is situated in direct contact with the barrier film along its entire height. The barrier film has a thickness that is greater than or equal to the thickness of the functional element. This is advantageous in order to achieve particularly reliable covering of the open edge of the functional element and thus optimum aging resistance. At the same time, standardized film thicknesses of the barrier film can still be used, selecting the commercially available barrier film that exceeds the thickness of the functional element and comes closest to it. Here again, the maximum thickness deviations already discussed in this connection of preferably at most 30%, particularly preferably at most 20%, in particular at most 15%, are considered advantageous in order to reduce the internal stresses of the glazing.

The barrier film has a thickness of 0.1 mm to 1.0 mm, preferably of 0.3 mm to 0.5 mm, particularly preferably of 0.40 mm to 0.45 mm. A wide variety of barrier films with different thicknesses are commercially available in these ranges. Mentioned here merely by way of example are polyethylene terephthalate films which are currently available in thicknesses of 0.10 mm, 0.40 mm, or 0.45 mm, among others. The commercial offering of different films is, however, constantly increasing such that an increasing selection of materials and film thicknesses can be expected in the future.

Functional elements comprising PDLC multilayer films are commercially available and usually have a total thickness of the PDLC multilayer stack of approx. 100 μm to 500 μm, preferably of 200 μm to 400 μm.

The first thermoplastic composite film, the second thermoplastic composite film, and/or the thermoplastic frame film contain, in each case, at least one plasticizer. Plasticizers are chemical compounds that make plastics softer, more flexible, smoother, and/or more elastic. They shift the thermoelastic range of plastics to lower temperatures such that the plastics have the desired more elastic properties in the range of the temperature of use. Preferred plasticizers are carboxylic acid esters, in particular low-volatility carboxylic acid esters, fats, oils, soft resins, and camphor. Other plasticizers are preferably aliphatic diesters of tri- or tetraethylene glycol. Particularly preferably used as plasticizers are 3G7, 3G8, or 4G7, where the first digit indicates the number of ethylene glycol units and the last digit indicates the number of carbon atoms in the carboxylic acid portion of the compound. Thus, 3G8 represents triethylene glycol-bis-(2-ethyl hexanoate), in other words, a compound of the formula C₄H₉CH (CH₂CH₃) CO (OCH₂CH₂)₃O₂CCH (CH₂CH₃) C₄H₉.

Preferably, the first thermoplastic composite film, the second thermoplastic composite film, and/or the thermoplastic frame film contain at least 3 wt.-%, preferably at least 5 wt.-%, particularly preferably at least 20 wt.-%, even more preferably at least 30 wt.-%, and in particular at least 40 wt.-% of a plasticizer. Preferably, the plasticizer contains or is made of triethylene glycol-bis-(2-ethyl hexanoate).

More preferably, the first thermoplastic composite film, the second thermoplastic composite film, and/or the thermoplastic frame film contain at least 60 wt.-%, particularly preferably at least 70 wt.-%, in particular at least 90 wt.-%, and, for example, at least 97 wt.-% polyvinyl butyral.

In the composite pane according to the invention, the plasticizer-poor barrier films are selected with a plasticizer content of less than 0.5 wt.-%. Most particularly preferably, the barrier film is plasticizer-free, in other words, without deliberate addition of a plasticizer.

Particularly preferably, plasticizer-free plastics are used. The barrier films contain in particular polyethylene terephthalate (PET) or polyvinyl fluoride (PVF) or are made therefrom. These materials can be obtained plasticizer-free, as a result of which the aging resistance of the functional element is further improved, compared to the use of plasticizer-poor barrier films.

In a particularly preferred embodiment of the method according to the invention, the material composition of the barrier film and of the thermoplastic composite film differs in terms of their main constituents by weight. The inventors were able to observe that with a similar choice of material of the components making direct contact, a certain diffusion of chemical compounds starting from the thermoplastic composite film through the barrier film to the open edges of the functional element occurs. This is completely or almost completely prevented by selecting a material for the barrier film that differs from that of the thermoplastic composite film not only in its plasticizer content but also in its main polymer constituent.

An embodiment including barrier films containing polyethylene terephthalate as the main constituent in combination with thermoplastic composite films containing polyvinyl butyral as the main constituent has proved to be particularly advantageous in terms of restricting the diffusion of plasticizers and other chemical compounds.

The thermoplastic composite films and the barrier film can be introduced into the layer stack of the composite pane either as individual film layers or inserted in the form of a pre-composite. Such a pre-composite comprises a plurality of films to be arranged adjacently in the composite pane. Pre-composites of two film layers, for example, of a barrier film and a thermoplastic composite film, are referred to as bilayers. During production of the composite pane according to the invention, simplified handling is ensured through the use of pre-composites (bilayers) of a thermoplastic composite film and a barrier film. The barrier film retains its intrinsic stability even in the case of complex geometries of the cutout into which the functional element is inserted. Furthermore, exact positioning is facilitated and slippage of the barrier film in the layer stack is prevented. In addition, when using a single barrier film, electrostatic effects occur, making handling even more difficult. Taping the open edge of the functional element, as known in the prior art, is not possible with complex geometries since wrinkling of the adhesive strip occurs.

Within the pre-composite, the barrier film is in direct contact with the corresponding thermoplastic composite film of the pre-composite. Consequently, the pre-composites according to the invention do not have any adhesion promoters, adhesion-improving coatings, and/or adhesives. The inventors have found that such bonding is not necessary when using pre-composites. More extensive details concerning the production and structure of the pre-composites are described in the course of the method according to the invention.

The thickness of the thermoplastic composite films is in each case preferably from 0.2 mm to 2 mm, particularly preferably from 0.3 mm to 1 mm, in particular from 0.3 mm to 0.5 mm, for example, 0.38 mm.

The composite pane according to the invention can contain one first thermoplastic composite film and one second thermoplastic composite film or even a plurality of first and/or second thermoplastic composite films. Consequently, instead of a first and/or second thermoplastic composite film, there can also be in each case a two-ply, three-ply, or multi-ply film stack comprising thermoplastic composite films and/or other functional films, wherein the individual films have the same or different properties. A thermoplastic composite film can also be formed from sections of different thermoplastic films whose lateral edges are adjacent.

In an advantageous further development of a composite pane according to the invention, the region of the thermoplastic composite films via which the functional element is joined to the first pane and/or the second pane is tinted or colored. The transmittance of this region in the visible spectral range is thus reduced compared to a non-tinted or non-colored layer. The tinted/colored region of the intermediate layer thus reduces the transmittance of the windshield in the region of the sun visor. In particular, the aesthetic impression of the functional element is improved because the tinting results in a more neutral appearance that affects the observer more pleasantly.

This tinting or coloring of the composite pane can be achieved by multiple measures that can also be combined with each other as needed. Generally speaking, it is possible to manufacture the first and/or the second pane from tinted or colored glass. Furthermore, the first and/or the second thermoplastic composite film, which can optionally also be used in the form of a bilayer with the barrier film, can be tinted or colored. Moreover, in addition to the first and second thermoplastic composite film, other tinted or colored films can be inserted into the layer stack. Films in which the tinted or colored region is produced by local tinting or coloring can also be used as a first, second, or even a further thermoplastic composite film. Such films can, for example, be obtained by coextrusion. Alternatively, a non-tinted film section and a tinted or colored film section can be combined to form the thermoplastic layer.

The tinted or colored region of the intermediate layer preferably has transmittance in the visible spectral range of 10% to 50%, particularly preferably of 20% to 40%. Particularly good results in terms of glare protection and optical appearance are thus obtained.

The tinted or colored region can be colored or tinted homogeneously, in other words, can have location-independent transmittance. The tinting or coloring can, however, also be inhomogeneous; in particular, a transmittance progression can be realized. In one embodiment, the transmittance level in the tinted or colored region decreases, at least in sections, with increasing distance from the upper edge. Thus, sharp edges of the tinted or colored area can be avoided such that the transition from a PDLC functional element used as a sun visor into the transparent region of the windshield is gradual, which appears more attractive aesthetically.

In an advantageous embodiment, the second pane is the outer pane and the region of the second thermoplastic composite film, i.e., the region between the functional element and the outer pane is tinted. This creates a particularly aesthetic impression when the outer pane is viewed from above. Optionally, the region of the first thermoplastic composite film between the functional element and the inner pane (first pane) can additionally be colored or tinted.

In a preferred embodiment of the composite pane according to the invention, the first and the second thermoplastic composite film are tinted. Between the second pane (here: outer pane) and the second thermoplastic composite film, a carrier film with an infrared reflecting coating, followed by a further thermoplastic composite film, is inserted into the layer stack. The carrier film with an infrared reflecting coating is bonded via the second thermoplastic composite film onto the functional element after lamination of the layer stack, while the bonding to the second pane is done via the further thermoplastic composite film. The first thermoplastic composite film ensures bonding to the first pane either directly or, optionally, with interpositioning of a additional film components. Such a structure is, for example, advantageous as a roof panel of a motor vehicle since the infrared reflecting coating reduces the undesirable heating of the vehicle interior by solar radiation. In addition to the attractive design of the composite pane already mentioned, the tinted thermoplastic composite films also contribute to reducing the solar radiation. In another advantageous variant of this exemplary embodiment, a polymeric metal-free film, which itself has infrared reflecting properties, is used instead of a carrier film with an infrared reflecting coating. Such polymeric films without metallic constituents are commercially available. The infrared reflecting effect is created by a sequence of a large number of polymeric layers, on whose interfaces a partial reflection occurs in each case.

In the context of the invention, “electrically controllable optical properties” means those properties that are infinitely controllable but also those that can be switched between two or more discrete states.

The electrical control of the sun visor or of the switchable vehicle roof glazing is done, for example, using switches, rotary knobs, or sliders that are integrated into the dashboard of the vehicle. However, a switch area, for example, a capacitive switch area, for controlling the sun visor can also be integrated into the windshield or into the roof surface. Alternatively, or additionally, the sun visor can be controlled by contactless methods, for example, by gesture recognition, or as a function of the pupil or eyelid state detected by a camera and suitable evaluation electronics. Alternatively, or additionally, the sun visor can be controlled by sensors that detect light incidence on the pane.

The composite pane having an electrically controllable functional element can advantageously be implemented as a windshield or roof panel with an electrically controllable sun visor.

A windshield has an upper edge and a lower edge as well as two side edges extending between the upper edge and the lower edge. “Upper edge” refers to that edge that is intended to point upward in the installation position. “Lower edge” refers to that edge that is intended to point downward in the installation position. The upper edge is often referred to as the “roof edge”; the lower edge, as the “engine edge”.

A motor vehicle roof panel has a front edge that points toward the windshield and a rear edge that points in the direction of the rear window of the vehicle. The remaining edges of the roof panel are the side edges. The side edges extend between the front edge and the rear edge of the panel.

Windshields have a central field of vision, the optical quality of which is subject to high requirements. The central field of vision must have high light transmittance (typically greater than 70%). Said central field of vision is, in particular, that field of vision that is referred to by the person skilled in the art as field of vision B, vision area B, or zone B. The field of vision B and its technical requirements are specified in Regulation No. 43 of the Economic Commission for Europe of the United Nations (UN/ECE) (ECE-R43, “Uniform Provisions concerning the Approval of Safety Glazing Materials and Their Installation on Vehicles”). There, the field of vision B is defined in Annex 18.

In a windshield, the functional element is advantageously arranged above the central field of vision (field of vision B). This means that the functional element is arranged in the region between the central field of vision and the upper edge of the windshield. The functional element does not have to cover the entire area, but is positioned completely within this area, and does not protrude into the central field of vision. In other words, the functional element is less distant from the upper edge of the windshield than the central field of vision. Thus, the transmittance of the central field of vision is not adversely affected by the functional element which is positioned in a location similar to that of a conventional mechanical sun visor in the folded-down state.

The windshield is preferably intended for a motor vehicle, particularly preferably for a passenger car.

In a preferred embodiment of a windshield according to the invention, the lower edges of the functional element and of the tinted region of the intermediate layer(s) are adapted to the shape of the upper edge of the windshield, yielding a more appealing visual impression. Since the upper edge of a windshield is typically curved, in particular concavely curved, the lower edge of the functional element and of the tinted region is also preferably curved. Particularly preferably, the lower edges of the functional element are substantially parallel to the upper edge of the windshield. It is, however, also possible to construct the sun visor from two halves, each straight, arranged at an angle relative to one another, and forming a virtually V-shaped upper edge.

In one embodiment of the invention, the functional element is divided into segments by isolation lines. The isolation lines are in particular introduced into the surface electrodes such that the segments of the surface electrode are isolated from one another. The individual segments are connected to the voltage source independently of one another such that they can be actuated separately. Thus, different regions of the sun visor can be switched independently. Particularly preferably, the isolation lines and the segments are arranged horizontally in the installation position. Thus, the height of the sun visor can be controlled by the user. The term “horizontal” is to be interpreted broadly here and refers to a direction of extension that, in a windshield, runs between the side edges of the windshield. The isolation lines do not necessarily have to be straight, but can also be slightly curved, preferably adapted to possible curvature of the upper edge of the windshield, in particular substantially parallel to the upper edge of the windshield. Vertical isolation lines are, of course, also conceivable.

The isolation lines have, for example, a width of 5 μm to 500 μm, in particular 20 μm to 200 μm. The width of the segments, i.e., the distance between adjacent isolation lines can be suitably selected by the person skilled in the art according to the requirements of the individual case.

The isolation lines can be introduced by laser ablation, mechanical cutting, or etching during production of the functional element. Already laminated multilayer films can also be subsequently segmented by laser ablation.

Functional elements in roof panels are usually switched as complete areas. However, the roof panel according to the invention can also, as described for the windshield, be divided by isolation lines into individual switchable segments.

The upper edge and the side edges or all side edges of the functional element are concealed in through-vision through the composite pane preferably by an opaque masking print or by an outer frame. Windshields and roof panels typically have a circumferential peripheral masking print made of an opaque enamel, which serves in particular to protect the adhesive used for installation of the pane against UV radiation and to visually conceal it. This peripheral masking print is preferably used to also conceal the upper edge and the side edge of the functional element as well as the necessary electrical connections. The functional element is then advantageously integrated into the appearance of the pane. Only in the case of sun visors is the lower edge potentially discernible to the observer. Preferably, both the outer pane and also the inner pane have a masking print such that through-vision in the edge region is prevented from both sides.

The functional element can also have recesses or holes, for instance, in the region of so-called sensor windows or camera windows. These regions are provided to be equipped with sensors or cameras whose function would be impaired by a controllable functional element in the beam path, for example, rain sensors. It is also possible to realize the sun visor with at least two functional elements separated from one another, with a distance between the functional elements providing space for sensor windows or camera windows.

The functional element (or the totality of the functional elements in the above-described case of a plurality of functional elements) is preferably arranged over the entire width of the composite pane, minus an edge region having a width of, for example, 2 mm to 20 mm. The functional element is thus encapsulated within the intermediate layer and protected against contact with the surrounding atmosphere and corrosion.

The first and the second pane are preferably made of glass, particularly preferably of soda lime glass, as is customary for window panes. The panes can, however, also be made of other types of glass, for example, quartz glass, borosilicate glass, or aluminosilicate glass, or rigid clear plastics, for example, polycarbonate or polymethyl methacrylate. The panes can be clear, or also tinted or colored. Windshields must have adequate light transmittance in the central field of vision, preferably at least 70% in the primary through-vision zone A per ECE-R43.

The first pane, the second pane, and/or the intermediate layer can have further suitable coatings known per se, for example, antireflection coatings, nonstick coatings, anti-scratch coatings, photocatalytic coatings, or solar protection coatings, or low-E coatings.

The thickness of the first and the second pane can vary widely and thus be adapted to the requirements of the individual case. The first and the second pane preferably have thicknesses of 0.5 mm to 5 mm, particularly preferably of 1 mm to 3 mm.

The invention further includes a method for producing a composite pane with a functional element. Therein, a first thermoplastic composite film is arranged sheet-wise on a first pane, and a functional element with a barrier film surrounding the functional element in a frame-like manner is arranged on the first thermoplastic composite film. The barrier film is immediately adjacent the peripheral edge of the functional element. The barrier film and the functional element can be applied one after another in any order or even simultaneously. A second thermoplastic composite film is placed on the functional element and the barrier film, and subsequently a second pane is placed thereon. The layer stack is bonded by autoclaving to form a composite pane.

The method according to the invention provides a composite pane having a functional element with high aging resistance. The barrier film surrounds the functional element in a frame-like manner and is in direct contact with the peripheral edge. The peripheral edge of the functional element is thus sealed by means of the barrier film such that entry of plasticizers from the thermoplastic composite films into active layer of the functional element is prevented. The barrier film itself contains at most 0.5 wt.-% plasticizer and prevents the diffusion of plasticizer through the barrier film. Moreover, with appropriate thickness of the barrier film, it is possible to dispense with a thermoplastic frame film, thus saving a process step in the method according to the invention.

In a particularly preferred embodiment of the method according to the invention, the barrier film is inserted into the layer stack as a pre-composite together with the first thermoplastic composite film or the second thermoplastic composite film.

The method according to the invention enables easy handling through the use of the pre-composite (bilayers) made of a thermoplastic composite film and the barrier film. Because of the fact that these films are used as bilayers, the barrier film retains its inherent stability. In particular, in the case of large functional elements, the barrier film adapted in size to the functional element is a low-width unstable frame, which, nevertheless, must be applied with an exact fit in order to prevent slippage in the layer stack. This stability problem is avoided by the method according to the invention. In addition, when using a single barrier film, electrostatic effects occur, making handling even more difficult. By means of the use according to the invention of bilayers, the barrier film can be made in any shape. This enables even a rounded or round edge design of the functional element. Taping the open edges of the functional element, as known in the prior art, is not possible with rounded geometries since wrinkling of the adhesive tape occurs. By means of the method according to the invention, air bubble inclusions and resultant optical defects or adverse effects are avoided since the barrier films rest evenly and at the peripheral edge of the functional element.

In a possible embodiment, the first thermoplastic composite film is first placed on the first pane and the functional element is placed thereon. The barrier film is then placed, in the form of a pre-composite of the barrier film and the second composite film, on the functional element such that the barrier film surrounds the peripheral edge of the functional element. Thereafter, if provided, possible additional layers of the layer stack are placed thereon and, following that, the second pane. As described, the functional element can be placed first on the first composite film and, after that, the barrier film with the second composite film can be placed as a bilayer on the already aligned functional element; however, it is also possible, conversely, to first place a bilayer composed of the composite film and the barrier film on the pane and to place the functional element in the cutout of the barrier film. The order of the steps can be freely selected.

The pre-composite according to the invention has no adhesion promoters, adhesion-enhancing coatings, and/or adhesives at all. This is true for all of the film surfaces of the pre-composite. Neither between the barrier films and the associated thermoplastic composite film in the bilayer, nor between the barrier film and the functional element, is there an adhesion promoter. This absence of an adhesion promoter is a distinguishing feature relative to the prior art structures, in which fixation is essential to prevent slippage of the barrier film during assembly of the layer stack. The prior art also includes the teaching that in order to produce a sufficient diffusion barrier for plasticizer, gluing of the elements to be sealed is necessary. The inventors have discovered that this is, astonishingly, not necessary; and by means of the method according to the invention, an excellent diffusion barrier for plasticizer can be obtained even without gluing. Diffusion of plasticizers and other chemical compounds out of the thermoplastic composite films into the active layer of the functional element can thus be effectively prevented and an undesirable brightening of the edge region of the functional element due to plasticizer is prevented. Using a bilayer per the method according to the invention further yields low susceptibility to defects during the production process, enabling a high degree of automation. Thus, the method according to the invention makes a composite pane with a functional element having improved aging resistance available with significantly reduced production costs.

The pre-composite composed of one of the thermoplastic composite films and the barrier film is produced before the assembly of the individual layers of the composite pane. Preferably, the barrier film is joined to one of the thermoplastic composite films to form a pre-composite by heating. Preferably, the barrier film and the thermoplastic film, which are to be formed into a pre-composite, are heated and pressed together. This exertion of pressure in the heated state creates a stable pre-composite that does not separate even upon cooling of the films. The steps of heating and pressing the films can be carried out in succession, for example, by passing the barrier film and the thermoplastic film together through a heater battery and subsequently pressing them together by a pair of rollers. In a particularly preferred embodiment, a heated pair of rollers that presses the barrier film and the thermoplastic composite film together and joins them, in one step, to form a pre-composite is used. Using a pair of rollers for joining the films is particularly advantageous since air inclusions between the film components are reliably removed. The pre-composite produced from a barrier film and a thermoplastic composite film can be wound onto a roll and thus optionally produced and stocked in advance.

It has proved advantageous to heat the barrier film and/or the thermoplastic composite film to a temperature of 35° C. to 75° C., preferably of 35° C. to 60° C., particularly preferably of 40° C. to 50° C., and to press them together sheet-wise under pressure to form a pre-composite. Within these temperature ranges, the films adhere well to each other. The barrier film and the thermoplastic composite film can both be heated to different temperatures. Preferably, they are heated to the same temperature. In a particularly advantageous embodiment, the barrier film and the thermoplastic composite film are in each case unwound from a roll, routed through a pair of rollers at a temperature of 45° C., and pressed together sheet-wise and wound onto a roll as a pre-composite.

Preferably, the pre-composite is first created from a substantially congruently arranged thermoplastic composite film and a barrier film. Then, the barrier film of the pre-composite is removed in at least one cutout. When the layer stack is assembled, the functional element is placed in this cutout. By making a cutout in the barrier film, an inner edge of the barrier film is created along the cutout. The size of the cutout is dimensioned such that the barrier film surrounds the functional element in the form of a passe-partout. The inner edge of the barrier film and the peripheral edge of the functional element are in direct contact. The barrier film is a continuous, uninterrupted frame. This is advantageous in terms of secure sealing of the functional element. With the use of pre-composites, the frame-like barrier film is particularly easy to position. The barrier film is thus present only in the edge region of the functional element, where sealing of the open edges of the functional element is necessary. The functional element and the barrier film do not overlap at all. This is advantageous since the functional element usually has carrier films as outer layers, which are frequently made of PET. If PET is also selected for the barrier films, the two PET films would have no adhesion to one another such that there is an increased risk of optical defects and air inclusions. Consequently, it is advantageous for the functional element and the barrier layer not to overlap since the selection of material of the barrier film is thus not restricted. These statements also apply to the product and the statements made for the product also apply to the method claimed.

In a preferred embodiment of the method according to the invention, no thermoplastic frame film is inserted into the layer stack, since the barrier film already assumes the thickness compensating function of the frame film.

The electrical contacting of the surface electrodes of the functional element is preferably done prior to lamination of the composite pane.

Any imprints, for example, opaque masking prints or printed bus bars for the electrical contacting of the functional element are preferably applied by screen printing.

The lamination is preferably done under the action of heat, vacuum, and/or pressure. Lamination methods known per se can be used, for example, autoclave methods, vacuum bag methods, vacuum ring methods, calender methods, vacuum laminators, or combinations thereof.

The method according to the invention enables production of a composite pane according to the invention that has improved sealing of the peripheral edge without requiring gluing of the barrier films to the adjacent film components (thermoplastic composite film, other barrier film) or to the functional element. This absence of adhesives or other point-wise fixation of the barrier films is evident from the composite pane.

The statements already made in the description of the method according to the invention regarding the composite pane resulting from the method also naturally apply to the pane itself and vice versa.

The invention further includes the use of a composite pane according to the invention having an electrically controllable functional element as interior glazing or exterior glazing in a vehicle or a building, wherein the electrically controllable functional element is used as a sun screen or as a privacy screen.

The invention further includes the use of a composite pane according to the invention as a windshield or roof panel of a vehicle, with the electrically controllable functional element being used as a sun visor.

A major advantage of the invention consists in that with composite panes as a windshield, it is possible to dispense with a conventional mechanically foldable sun visor mounted on the vehicle roof.

The invention is explained in detail with reference to drawings and exemplary embodiments. The drawings are schematic representations and not to scale. The drawings in no way restrict the invention. They depict:

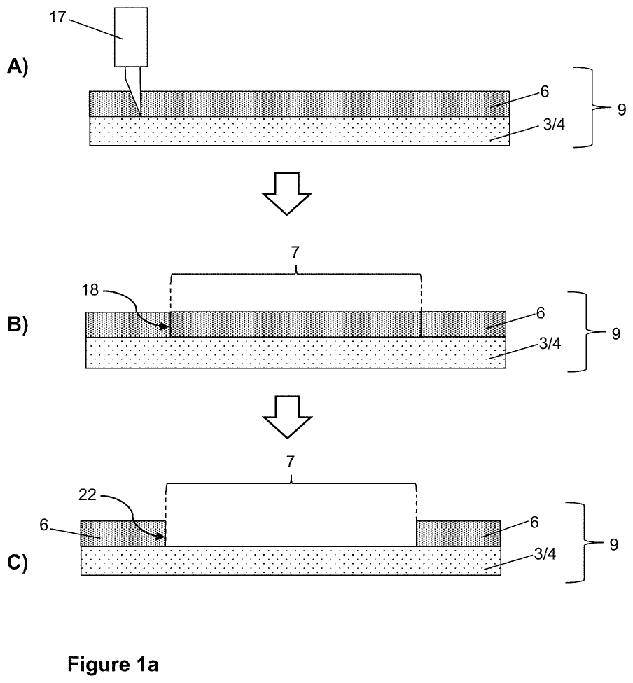

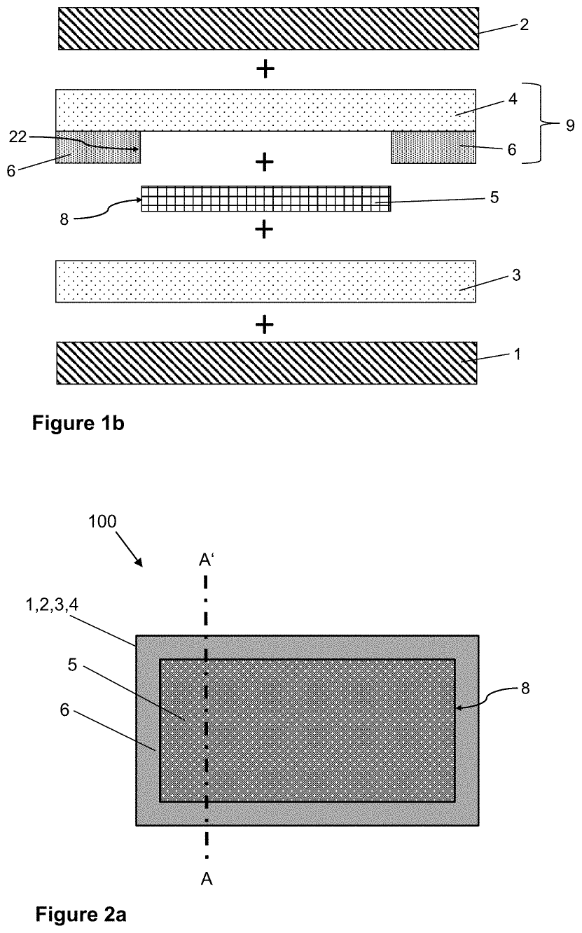

FIG. 1a a cross-section of a pre-composite comprising a barrier film and a thermoplastic composite film during the cutting of the film to size,

FIG. 1b a layer stack of an embodiment of the composite pane according to the invention prior to lamination of the pane,

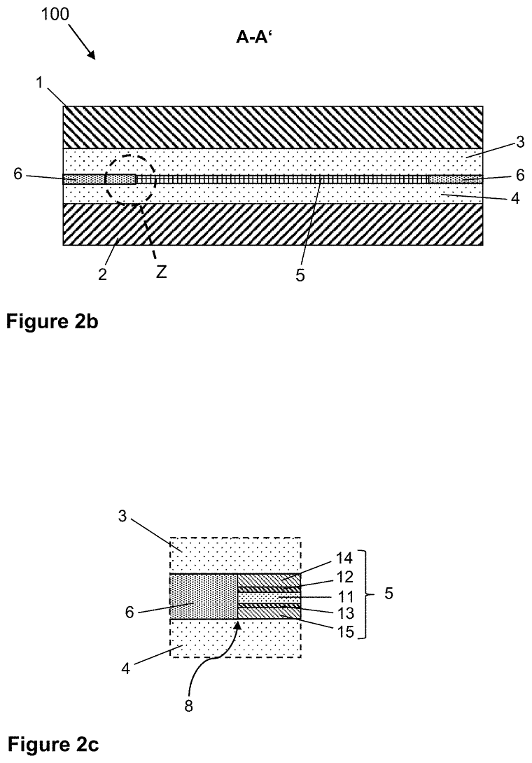

FIG. 2a a plan view of an embodiment of the composite pane according to the invention,

FIG. 2b a cross-section through the composite pane of FIG. 2a along the section line A-A′,

FIG. 2c an enlarged representation of the region Z of FIG. 2b,

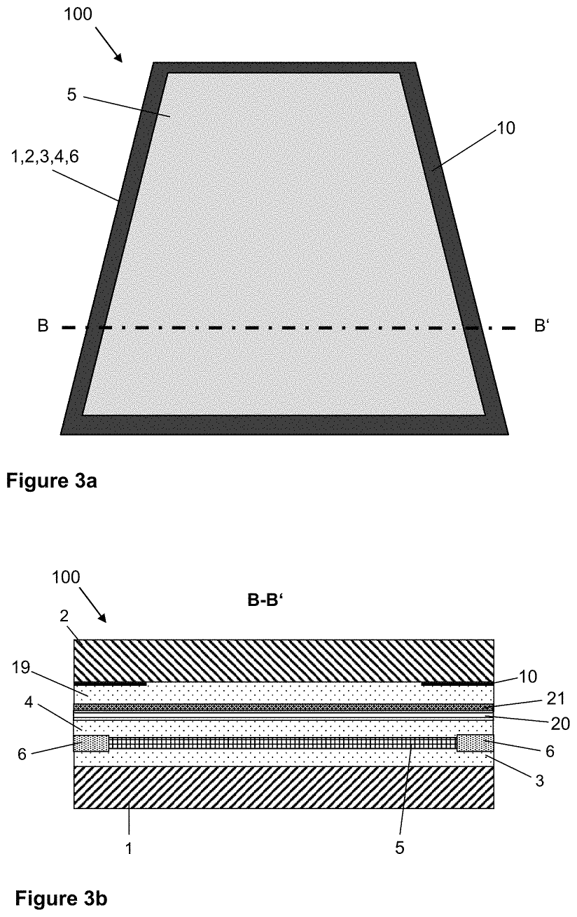

FIG. 3a a plan view of another embodiment of a composite pane according to the invention as a roof panel with a functional element,

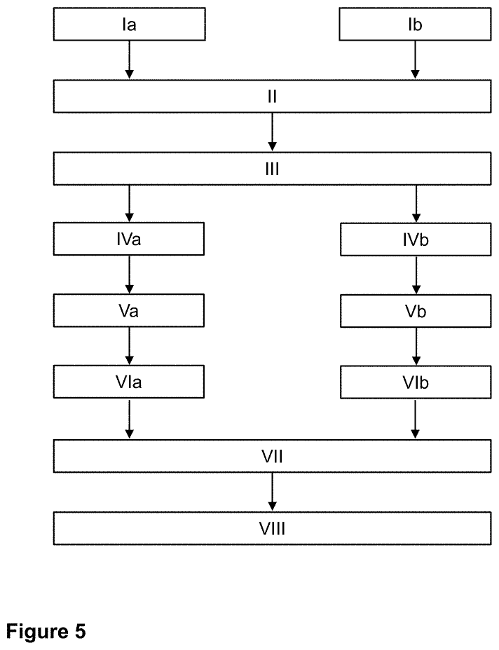

FIG. 3b a cross-section through the composite pane of FIG. 5a along the section line B-B′,

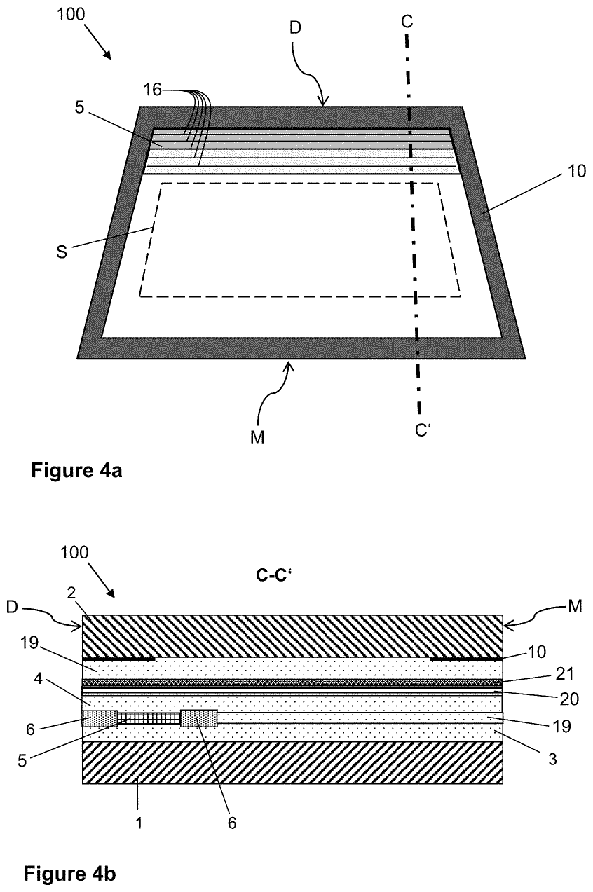

FIG. 4a a plan view of another embodiment of a composite pane according to the invention as a windshield with a sun visor,

FIG. 4b a cross-section through the composite pane of FIG. 5a along the section line B-B′,

FIG. 5 an exemplary embodiment of the method according to the invention using a flowchart.

FIG. 1 a depicts a pre-composite 9 according to the invention comprising a thermoplastic composite film 3 or 4 and a barrier film 6 and the processing steps for cutting the barrier film 6 to size, represented as states A to C. This can be a composite 9 of the first thermoplastic composite film 3 with the barrier film 6, or a composite 9 of the second thermoplastic composite film 4 with the second barrier film 6. The pre-composite 9 per state A) in FIG. 1a was produced by routing a thermoplastic composite film 3 or 4 together with a barrier film 6 through a heated pair of rollers with a temperature of 45° C. and a speed of 4 m/min. The rollers press the films together under heating, bonding them to form a pre-composite. The thermoplastic composite film 3 or 4 is made of 78 wt.-% polyvinyl butyral (PVB) and 20 wt.-% triethylene glycol bis(2-ethyl hexanoate) as plasticizer and have in each case a thickness of 0.38 mm, while the barrier film 6 is made substantially of polyethylene terephthalate (PET) and is 400 μm thick. Here, the barrier film 6 is made, for example, substantially of PET, i.e., at a rate of at least 97 wt.-%. The barrier film 6 contains less than 0.5 wt.-% plasticizer and is preferably plasticizer-free. The barrier film 6 is suitable to decisively reduce or prevent the diffusion of plasticizer out of the thermoplastic composite films 3, 4. In such a pre-composite 9, cuts 18 are made in the barrier film 6 of the pre-composite 9 using a cutting tool 17. The cutting depth is selected such that the thermoplastic composite film 3 or 4 remains substantially undamaged. The cuts 18 made in the barrier film 6 produce a cutout 7 in the surface of the barrier film 6. The barrier film remains only in the form of a peripheral frame in the edge region of the later composite pane. At the location where the cuts 18 were made, an inner edge 22 of the barrier film results.

Suitable cutting tools 17 are known to the person skilled in the art. A plotter equipped with a cutting blade has, for example, proved to be quite suitable. However, other methods can also be used, such as laser cutting. The barrier film 6 is removed in the region of the cutout 7. This is possible by lifting the barrier film 6 to be detached at the edge of a cut 18. Starting from such a raised corner, the regions of the barrier film 7 to be removed are peeled off. This is possible with morate expenditure of force and without damaging the films. The inner edge 22 of the barrier film 6 extends, set back inward relative to the outer edge of the subsequent composite pane, in the direction of the center of the barrier film 6. The inner edge 22 runs peripherally and forms a passe-partout, into which a functional element can be inserted. The amount by which the inner edge 22 is set back relative to the subsequent outer edge of the composite pane in the direction of the center of the pane can be variable or constant along the peripheral edge. This variability is made possible above all by the use of a pre-composite, which enables a substantially more precise positioning of the films in the layer stack. A pre-composite 9 is created comprising a continuous thermoplastic composite film 3 or 4 and a frame-like barrier film 6, which is present only at the points of the pre-composite where it is required for the sealing of the functional element (see C) in FIG. 1a). A single barrier film 6 cut like a frame has only low dimensional stability such that it cannot be handled by machine and can hardly be handled manually. By using a bilayer (pre-composite 9) according to the invention, the barrier film 6 can be cut in any desired geometries without restrictions. The stability and manageability of the arrangement is always ensured by the thermoplastic composite film 3 or 4. Accordingly, the use of bilayers is crucial to the automation of the process and to the variable shaping of the functional element.

FIG. 1b depicts a layer stack for producing the composite pane according to the invention using the pre-composite per FIG. 1a. The plus signs situated between the plies of the layer stack indicate the layer sequence in which the components are arranged on one another. A first thermoplastic composite film 3 is placed on a first pane 1 made of a clear soda lime glass with a thickness of 1.6 mm. The first pane 1 per FIG. 1b represents the inner pane of the windshield of a motor vehicle. A functional element 5 is placed on the first thermoplastic composite film 3. The functional element is implemented as a PDLC element with a thickness of 400 μm. A bilayer (pre-composite 9 per FIG. 1a) which comprises a second thermoplastic composite film 4 and a barrier film 6 and which points with the barrier film 4 in the direction of the functional element 5 is applied on the functional element 5. The barrier film 6 and the functional element 5 are coordinated with one another in their dimensioning such that the peripheral edge 8 of the functional element 5 is enclosed in a frame-like manner by the inner edge 22 of the barrier film 6. The inner edge 22 of the barrier film 6 and the peripheral edge 8 of the functional element 5 are in direct contact after assembly and autoclaving of the layer stack to form a composite pane. The barrier film 6 has a thickness of 400 μm and thus completely covers the edge 8 of the functional element. Since the functional element and the barrier film 6 have substantially the same thickness (400 μm), there is not only good edge sealing of the functional element 5, but also good thickness compensation via the barrier film 6. A second pane 2 is placed above the second thermoplastic composite film 4, completing the layer stack. The second pane 2 has a thickness of 2.1 mm and and is also made, for example, of a clear soda lime glass. In this case, the second pane 2 is the outer pane of the windshield and is bent congruently together with the first pane.

The barrier film 6 is trimmed per FIG. 1a such that it is suitable in its dimensions to surround the peripheral edge 8 of the functional element 5 per FIG. 1b. Any other films, for example functional films or colored films can be arranged between the first thermoplastic composite film 3 and the first pane 1 or between the second thermoplastic composite film 4 and the second pane 2. The pre-composite 9 remains in the vicinity of the functional element 5 with direct contact between the functional element 5 and the barrier film 6, even if the layer stack is expanded. Such a layer stack can be machine assembled. The use of pre-composites thus represents a significant simplification in terms of the production method of the composite pane. As an alternative to the composite pane described in FIG. 1b, a pre-composite 9 comprising a first thermoplastic composite film 3 and a barrier film 6 can be used analogously.

FIG. 2a depicts an embodiment of a composite pane 100 according to the invention comprising a first pane 1, a second pane 2, a first thermoplastic composite film 3, a second thermoplastic composite film 4, a barrier layer 6 and a functional element 5. FIG. 2b depicts a cross-section of the composite pane per FIG. 2a along the section line A-A′. An enlargement of the region Z of FIG. 2b is presented in FIG. 2c. The composite pane 100 can, for example, be arranged as an architectural glazing in the frame of a window with additional panes to form an insulating glazing unit. The first and the second pane 1, 2 are made of clear soda lime glass with a thickness 2.0 mm in each case. The first pane 1 and the second pane 2 are joined to one another via the first thermoplastic composite film 3 and the second thermoplastic composite film 4. A functional element 5, which is also bonded to the panes 1, 2 via the thermoplastic composite films 3, 4, is inserted between the first thermoplastic composite film 3 and the second thermoplastic composite film 4. A barrier film 6, which encloses the peripheral edge 8, is arranged along the peripheral edge 8 of the functional element. Since the peripheral edge 8 of the functional element 5 is completely enclosed by the barrier film 6, in aging tests, the composite pane 100 with the functional element 5 shows either no brightening or hardly any visually perceptible brightening in the edge region of the functional element 5. According to the invention, diffusion of the plasticizer out of the thermoplastic composite film 3, 4 into the functional element 5 and degradation of the functional element 5 associated therewith are avoided. Furthermore, the barrier film 6 serves for thickness compensation between the region of the pane with the functional element 5 and the region of the pane without the functional element 5. An additional thermoplastic frame film is therefore not required.

The optical properties of the functional element 5 can be controlled by applying an electrical voltage. For the sake of simplicity, the electrical supply lines are not shown.

The controllable functional element 5 is, for example, a PDLC multilayer film, consisting of an active layer 11 between two surface electrodes 12, 13 and two carrier films 14, 15. The active layer 11 contains a polymer matrix with liquid crystals dispersed therein, which align themselves as a function of the electrical voltage applied on the surface electrodes, by which means the optical properties can be controlled. The carrier films 14, 15 are made of PET and have a thickness of, for example, 180 μm. The carrier films 14, 15 are provided with a coating of ITO facing the active layer 11 and having a thickness of approx. 100 nm, forming the surface electrodes 12, 13. The surface electrodes 12, 13 can be connected to a voltage source via bus bars (not shown) (implemented, for example, by a silver-containing screen print) and connecting cables (not shown).

The thermoplastic composite films 3, 4 comprise in each case a thermoplastic film with a thickness of 0.38 mm and are made, for example, of 78 wt.-% polyvinyl butyral (PVB) and 20 wt.-% triethylene glycol bis(2-ethyl hexanoate) as a plasticizer.

The barrier film 6 is made, here, for example, substantially of PET, i.e., at a rate of at least 97 wt.-%. The barrier film 6 contains less than 0.5 wt.-% plasticizer and is suitable for preventing the diffusion of plasticizer out of the thermoplastic composite layers 3, 4 via the peripheral edge 8 into the functional layer 5.

The barrier film 6 has a thickness of 450 μm, whereas the functional element has a thickness of 400 μm. Since the thickness of the barrier film 6 exceeds the thickness of the functional element 5, the inner edge 22 of the barrier film completely covers the peripheral edge of the functional element.

The barrier film 6 is in direct contact with the functional element 5, in the present case by direct contact with the open cross-section of the functional element 5 along the peripheral edge 8. The barrier film 6 has no overlap at all in the form of a contact of the film surfaces, but rather enables deliberate selective edge sealing through direct contact of the side edges. In this context, “film surfaces” refers to the surfaces of the films running substantially parallel to the panes 1, 2, while the film edges have a course essentially orthogonal to the panes 1, 2. Here, “direct contact” means that no further components or chemical compounds at all, for example, adhesives, are arranged between the barrier film 6 and the functional element 5. According to the prior art, slippage of the barrier films during assembly is prevented by adhesive connections. According to the invention, an adhesive connection is unnecessary and undesirable. Slippage of the barrier films is achieved through the use of the pre-composite 9, which comprises the barrier film 6 and one of the thermoplastic composite films 3 or 4. The embodiment of the invention described in FIGS. 2a, 2b, and 2c includes a pre-composite 6 produced per FIG. 1a. The use of pre-composites ensures not only a shifting of the barrier film in the layer stack, but also facilitates the assembly of the layer stack. At the same time, inclusion of air bubbles and resultant optical disturbances or impairments are avoided since the barrier film 6 lies evenly at the peripheral edge of the functional element 5. The barrier film 6 according to the invention is firmly fixed in the region of the peripheral edge 8 of the functional element 5 by the internal pressure in the finished laminated composite pane 100 and pressed against the adjacent film components, resulting in a hermetic seal even without the use of adhesives. This was unexpected and surprising for the person skilled in the art.

FIG. 3a depicts a plan view of an embodiment according to the invention of a composite pane 100 as a roof panel of a motor vehicle. FIG. 3b depicts a cross-section of the roof panel per FIG. 3a along the section line BB′. The roof panel comprises a first pane 1, a second pane 2, a first thermoplastic composite film 3, a second thermoplastic composite film 4, a barrier layer 6, and a functional element 5. The first and the second pane 1, 2 are bent congruently with one another. The second pane 2 is the outer pane of the glazing, in other words, it is oriented toward the vehicle's surroundings, whereas the first pane 1 is the inner pane of the composite pane is and points toward the vehicle interior. The second pane 2 is made of clear soda lime glass with a thickness of 2.1 mm. The first pane 1 is made of soda lime glass with a thickness of 1.6 mm and is tinted gray. The tinted inner glass contributes to the attractive appearance of the pane, even for the vehicle occupant when looking through the roof panel. The first pane 1 and the second pane 2 are joined to one another via the first thermoplastic composite film 3, the second thermoplastic composite film 4, and an additional thermoplastic composite film 19. A functional element 5 that is likewise bonded to the panes 1, 2 via the thermoplastic composite films 3, 4 is inserted between the first thermoplastic composite film 3 and the second thermoplastic composite film 4. A first barrier film 6 that encloses the peripheral edge 8 is arranged along the peripheral edge 8 of the functional element. For this purpose, the barrier film 6 rests along the peripheral edge 8 of the functional element 5 directly at this edge. Thus, the peripheral edge 8 of the functional element 5 is completely closed and sealed by the barrier film 6. The composite pane 100 with the functional element 5 shows, in aging tests, either no or hardly any visually perceptible brightening in the edge region of the functional element 5. According to the invention, diffusion of the plasticizer out of the thermoplastic composite films 3a, 4a into the functional element 5 and degradation of the functional element 5 associated therewith are avoided. The first thermoplastic composite film 3 and the second thermoplastic composite film 4 are tinted gray to make the appearance of the pane attractive. The additional thermoplastic composite film 19 is colorless and is attached adjacent the outer pane (second pane 2). The additional thermoplastic composite film 19 serves to incorporate an additional carrier film 20 having an infrared reflecting coating 21 into the layer stack. The additional carrier film 20 is a PET film with a thickness of 50 μm, that is attached between the additional thermoplastic composite film 19 and the second thermoplastic composite film 4. The infrared reflecting coating 21 is oriented in the direction of the second pane 2 (outer pane) and is used to reduce heating of the passenger compartment by solar radiation.

The optical properties of the functional element 5 can be controlled by applying an electrical voltage. For the sake of simplicity, the electrical supply lines are not shown. The controllable functional element 5 is, for example, a PDLC multilayer film, comprising an active layer 11 between two surface electrodes 12, 13 and two carrier films 14, 15. The further structure of the functional element corresponds to that described in FIG. 2a-2c.

The thermoplastic composite films 3, 4 and the barrier film 6 correspond in their chemical composition and their layer thickness to the dimensions described in FIG. 2a-2c. Here, the barrier film 6 also ensures thickness compensation between the regions with and without the functional element 5 such that an additional thermoplastic frame film is, consequently, unnecessary.

The edge region of the roof panel is concealed by a circumferential black print 10 (circumferential peripheral masking print) that is applied at least on the inner side of the outer pane. The black print is formed by printing an opaque enamel onto the interior-side surface (facing the interior of the vehicle in the installed position) of the second pane 2. Optionally, a black print 10 can also be applied on the inner side of the first pane 1. The peripheral edge 8 of the functional element 5 lies in the region of the black print 10 such that it is not perceptible when viewing the roof panel from the outside. The distance of the functional element 5 from the peripheral edge of the roof panel is thus smaller than the width of the black print 10. The electrical connections (not shown) are also reasonably mounted in the region of the black print 10 and thus hidden.

The barrier film 6 is in direct contact with the functional element 5, in the present case, in sheet-wise contact with the surfaces of the carrier films 14, 15, and, additionally, in direct contact with the open cross-section of the functional element 5 along the peripheral edge 8. Also, according to the exemplary embodiment of FIGS. 3a and 3b, no adhesive or other adhesion-promoting substances at all are used; instead, the barrier film 6 is used as pre-composites 9 per FIGS. 1a and 1b with one of the thermoplastic composite films 3, 4. The barrier film 6 according to the invention in the region of the peripheral edge 8 of the functional element 5 is firmly fixed there by the inner pressure in the finished laminated composite pane 100 and pressed against the adjacent film, as a result of which hermetic sealing occurs even without the use of adhesives. This was unexpected and surprising for the person skilled in the art.

FIG. 4a depicts a plan view of another embodiment of a composite pane 100 according to the invention as a windshield with an electrically controllable sun visor. The PDLC functional element 5 is divided by horizontal isolation lines 16 into six strip-like segments. The isolation lines 16 have, for example, a width of 40 μm to 80 μm and are spaced 3.5 cm apart. They were introduced into the prefabricated multilayer film by laser. The isolation lines 16 separate, in particular, the electrodes 12, 13 into strips isolated from one another, which have, in each case, a separate electrical connection. The segments can thus be switched independently of one another. The thinner the isolation lines 16, the less conspicuous they are. Even thinner isolation lines 16 can be realized by etching.

The height of the darkened functional element 5 can be adjusted by the segmentation. Thus, depending on the position of the sun, the driver can darken the entire sun visor or even only part of it. The figure indicates that the upper half of the sun visor is darkened and the lower half is transparent.

In a particularly convenient embodiment, the functional element 5 is controlled by a capacitive switch area arranged in the region of the functional element, wherein the driver determines the degree of darkening by the location at which he touches the pane.

The windshield per FIGS. 4a and 4b comprises a trapezoidal composite 100 with a first pane 1 as an inner pane and a second pane 2 as an outer pane that are joined to one another via two thermoplastic composite films 3, 4. The second pane 2 has a thickness of 2.1 mm and is made of a green-colored soda lime glass. The first pane 1 has a thickness of 1.6 mm and is made of a clear soda lime glass. The windshield has an upper edge D facing the roof in the installed position and a lower edge M facing the engine compartment in the installed position. The cross-section of the composite pane 100 is shown in detail in FIG. 4b. This corresponds substantially to the structure per FIG. 3b. However, in deviation therefrom, an additional thermoplastic composite film 19 is inserted outside the region in which the functional element 5 is inserted in the composite pane 100. This additional composite film 19 borders laterally on the barrier film 6 that serves to seal the functional element. In this case, the thickness compensation between regions with and without the functional element is done via the barrier film 6 and the additional thermoplastic composite film 19 arranged adjacent it.

The sun visor is formed by a commercially available PDLC multilayer film as the functional element 5 that is embedded in the plastic composite films. The height of the sun visor b is, for example, 21 cm. The first thermoplastic composite film 3 is bonded to the first pane 1; the second thermoplastic composite film 4 is bonded to the second pane 2. In the region of the peripheral edge 8 of the functional element 5, a barrier film 6 that surrounds the edge 8 and seals the functional element 5 is inserted into the layer stack. The barrier film 6 is used as a pre-composite 9 with the second thermoplastic composite film 4.

The second thermoplastic composite film 4 has a tinted region that is arranged between the functional element 5 and the second pane 2 (outer pane). The light transmittance of the windshield is thus additionally reduced in the region of the functional element 5, and the milky appearance of the PDLC functional element 5 in the diffuse state is mitigated. The aesthetics of the windshield are thus significantly more attractive. The second thermoplastic composite film 4 has, in the tinted region, for example, average light transmittance of 30%, with which good results are achieved. The region can be homogeneously tinted. However, it is often visually more appealing if the tinting decreases in the direction of the lower edge of the functional element 5 such that the tinted and the non-tinted regions merge smoothly.

The lower edge of the tinted region and the lower edge of the PDLC functional element 5 can be arranged flush with one another. This is, however, not necessarily the case. It is also possible for the tinted region to protrude beyond the functional element 5 or, vice versa, for the functional element 5 to protrude beyond the tinted region. In the latter case, it would not be the entire functional element 5 that would be bonded to the second pane 2 via the tinted region.

The controllable functional element 5 is a multilayer film, analogous to the structure depicted in FIG. 2c, consisting of an active layer 11 between two surface electrodes 12, 13 and two carrier films 14, 15. The active layer 11 contains a polymer matrix with liquid crystals dispersed therein, which align themselves as a function of the electrical voltage applied to the surface electrodes, as a result of which the optical properties can be controlled. The carrier films 14, 15 are made of PET and have a thickness of, for example, 0.125 mm. The carrier films 14, 15 are provided with a coating of ITO facing the active layer 11 and having a thickness of approx. 100 nm, forming the electrodes 12, 13. The electrodes 12, 13 can be connected to the vehicle's electrical system, via busbars (not shown) (formed, for example, by a silver-containing screen print) and via connecting cables (not shown).

A so-called “high flow PVB”, which has stronger flow behavior compared to standard PVB films, can preferably be used for the thermoplastic composite films 3, 4, 19 per FIGS. 1 to 4. The layers thus flow around the barrier film 6 and the functional element 5 more strongly, creating a more homogeneous visual impression, and the transition from the functional element 5 to the composite films is less conspicuous. The “high flow PVB” can be used for all or even for only one or more of the thermoplastic composite films 3, 4, 19.

FIG. 5 depicts an exemplary embodiment of the method according to the invention comprising the steps:
Ia Producing a pre-composite 9 comprising a first thermoplastic composite film 3 and a barrier film 6
   or
Ib Producing a pre-composite 9 comprising a second thermoplastic composite film 4 and a barrier film 6
II Creating a cutout 7 in the barrier film 6 of the pre-composite 9, wherein the barrier film 6 is removed within the cutout 7
III Providing a first pane 1
IVa Placing the pre-composite 9 comprising the first thermoplastic composite film 3 and the barrier film 6 on the first pane 1, wherein the first thermoplastic composite film 3 is applied in the vicinity of the first pane 1
   or
IVb Placing a first thermoplastic composite film 3 on the first pane 1
Va Inserting a functional element 5 in the cutout 7 of the barrier film 6, wherein the barrier film 6 encloses the peripheral edge 8 of the functional element 5
   or
Vb Placing a functional element 5 on the first thermoplastic composite film 3

VIa Placing a second thermoplastic composite film 4 on the barrier film 6 and the functional element 5
or
VIb Placing the pre-composite 9 comprising the second thermoplastic composite film 4 and the barrier film 6 on the functional element 5, wherein the barrier film 6 is applied in the vicinity of the functional element and encloses the peripheral edge 8 of the functional element 5
VII Placing a second pane 2 on the second thermoplastic composite film 4
VIII Autoclaving the layer stack to form a composite pane 100

### LIST OF REFERENCE CHARACTERS

1 first pane
2 second pane
3 first thermoplastic composite film
4 second thermoplastic composite film
5 functional element having electrically controllable optical properties
6 barrier film
7 cutout (of the barrier film)
8 peripheral edge of the functional element 5
9 pre-composite comprising first thermoplastic composite film 3 or second thermoplastic composite film 4 and barrier film 6
10 black print
11 active layer of the functional element 5
12 first surface electrode of the functional element 5
13 second surface electrode of the functional element 5
14 first carrier film
15 second carrier film
16 isolation lines
17 cutting tool
18 cuts
19 additional thermoplastic composite films
20 additional carrier film
21 infrared reflecting coating
22 inner edge of the barrier film 6
100 composite pane
AA′, BB′, CC′ section lines
Z enlarged region
S field of vision B
M engine edge
D roof edge

1. A composite pane containing a functional element having electrically controllable optical properties comprising, in this order
a first pane,
a first thermoplastic composite film having at least one plasticizer,
a functional element having a peripheral edge,
a barrier film having a cutout, into which the functional element is inserted,
a second thermoplastic composite film having at least one plasticizer,
a second pane,
wherein
the barrier film surrounds the functional element in a frame-like manner and is in direct contact with the peripheral edge of the functional element, and
the barrier film contains at most 0.5 wt.-% plasticizer and prevents the diffusion of plasticizer through the barrier film.

2. The composite pane according to claim 1, wherein the functional element is a polymer dispersed liquid crystal (PDLC) film.

3. The composite pane according to claim 1, wherein a thickness of the barrier film and a thickness of the functional element differ from one another by at most 30%, and the thickness of the barrier film and the thickness of the functional element are substantially the same.

4. The composite pane according to claim 1, wherein the barrier film has a thickness of 0.1 mm to 1.0 mm.

5. The composite pane according to claim 1, wherein the first and/or the second thermoplastic composite film contains at least 3 wt. % of a plasticizer, and the plasticizer contains or is made of aliphatic diesters of tri- or tetraethylene glycol.

6. The composite pane according to claim 1, wherein the thermoplastic composite films contain at least 60 wt. % of polyvinyl butyral (PVB).

7. The composite pane according to claim 1, wherein the barrier film contains or is made of polyethylene terephthalate PET) or polyvinyl fluoride (PVF) and is plasticizer free.

8. The composite pane according to claim 1, wherein the material composition of the barrier film differs in terms of its main constituent by weight from the main constituent by weight of the thermoplastic composite films.

9. The composite pane according to claim 8, wherein the barrier film contains polyethylene terephthalate (PET) as the main constituent by weight and the thermoplastic composite films contain polyvinyl butyral (PVB) as the main constituent by weight.

10. The composite pane according to claim 1, wherein the barrier film in the form of a pre-composite comprising a barrier film and a first thermoplastic composite film or in the form of a pre-composite comprising a barrier film and a second thermoplastic composite film is inserted into the layer stack of the composite pane and the barrier film is in direct contact with the thermoplastic composite film of the pre-composite.

11. A method for producing a composite pane with a functional element according to claim 1, the method comprising:
arranging a first thermoplastic composite film sheet-wise on a first pane, arranging a functional element and a barrier film surrounding the peripheral edge of the functional element in a frame-like manner on the first thermoplastic composite film, arranging a second thermoplastic composite film on the functional element and the barrier film, placing a second pane placed on the second thermoplastic composite film, and bonding the layer stack by autoclaving to form a composite pane, wherein
the barrier film contains at most 0.5 wt.-% plasticizer and prevents the diffusion of plasticizer through the barrier film, and
the first thermoplastic composite film and the second thermoplastic composite film contain in each case at least one plasticizer.

12. The method according to claim 11, wherein the barrier film is inserted into the layer stack as a pre-composite together with the first thermoplastic composite film or the second thermoplastic composite film.

13. The method according to claim 12, wherein the barrier film is bonded to the first thermoplastic composite film or the second thermoplastic composite film under the action of heat and pressure to form a pre-composite.

14. The method according to claim 12, wherein a pre-composite is created from a substantially congruently arranged thermoplastic composite film and a barrier film, the barrier film of the pre-composite is removed in at least one cutout, and during assembly of the layer stack, the functional element is inserted into the cutout of the barrier film.

15. A method comprising utilizing a composite pane according to claim 1 as a windshield or roof panel of a vehicle, wherein the electrically controllable functional element serves as a sun visor or as a privacy screen.

16. The composite pane according to claim 3, wherein the thickness of the barrier film and the thickness of the functional element differ from one another by at most 20%.

17. The composite pane according to claim 4, wherein the barrier film has a thickness of 0.3 mm to 0.5 mm.

18. The composite pane according to claim 5, wherein the first and/or the second thermoplastic composite film contains at least 30 wt.-% of a plasticizer.

19. The composite pane according to claim 5, wherein the plasticizer contains or is made of triethylene glycol-bis-(2-ethyl hexanoate).

20. The composite pane according to claim 6, wherein the thermoplastic composite films contain at least 90 wt.-% of polyvinyl butyral (PVB).
